(19) United States
(12) Patent Application Publication
(10) Pub. No.: US 2026/0279857 A1
(43) Pub. Date: Sep. 17, 2026

(54) Ejector jet pump

(71) Applicant: MTU Aero Engines AG, Muenchen (DE)

(72) Inventors: Gionata LUISONI, Garching (DE); Thomas SCHERER, Starnberg (DE)

(21) Appl. No.: 19/472,798

(22) PCT Filed: Apr. 8, 2024
(86) PCT No.: PCT/DE2024/100284

§ 371 Date: Oct. 6, 2025

(30) Foreign Application Priority Data
Apr. 11, 2023 (DE) 10 2023 109 097.6

(51) Int. Cl. H01M 8/04119; F04F 5/24

(52) U.S. Cl. CPC H01M 8/04164; F04F 5/24; H01M 2250/20

(57) ABSTRACT

An ejector jet pump for a recirculation system of a fuel cell drive for humidifying and recirculating hydrogen in the fuel cell system, with at least one fuel cell, including a water separator for separating water and forming droplet-free gas from the moist exhaust gas of the fuel cell, and a gas delivery device arranged downstream of the water separator, wherein the water separator has a suction connection for feeding the exhaust gas into the water separator, wherein the water separator has a water outlet for discharging water separated from the moist exhaust gas, wherein the water separator has a droplet-free gas connection which opens into the gas delivery device. The water separator between the suction connection and the gas delivery device can be be tubular in shape and have a bend at an angle α. of at least 60°and at most 120°.

The invention relates to an ejector jet pump for a recirculation system of a fuel cell system of a fuel cell drive, in particular a fuel cell drive designed as an aircraft engine, for humidifying and recirculating hydrogen in the fuel cell system.

### BACKGROUND

Ejector jet pumps are commonly used for the recirculation of gaseous hydrogen in proton exchange membrane (PEM) fuel cells. Ejector jet pumps enable unused hydrogen, which exits as exhaust gas from the anode of a fuel cell, to be mixed with fresh hydrogen from a hydrogen tank and reused. Typically, the excess hydrogen leaving the fuel cell is very moist, with 90%-100% relative humidity and may even be mixed with liquid water. This moist excess hydrogen is used to humidify the dry hydrogen from the hydrogen tank before the mixture is fed back to the fuel cell. Humidification is an important function of the ejector jet pump, as it significantly improves the performance of the fuel cell. However, it is also important that no liquid water enters the fuel cell. For this reason, it is necessary to separate the liquid water component from the fuel cell system, especially from the recirculation circuit. This is usually achieved with a cyclone water separator.

### SUMMARY OF THE INVENTION

The use of an ejector jet pump in conjunction with a cyclone water separator for separating liquid water is often employed in the automotive industry, where fresh hydrogen comes from high-pressure tanks with a system pressure of 350-700 bar.

This means that in these cases a large amount of driving pressure is available for the use of the jet pump to enable recirculation in a closed circuit. Liquid hydrogen tanks which are pressurized only to between 5 and 10 bar are used in aviation applications.

It is an object of the present invention to provide an ejector jet pump that is more suitable for use in aviation.

An ejector jet pump according to the invention for a recirculation system of a fuel cell system of a fuel cell drive, in particular a fuel cell drive designed as an aircraft engine, for humidifying and recirculating hydrogen in the fuel cell system. The ejector jet pump with at least one fuel cell comprises a water separator for separating liquid water and forming droplet-free gas from moist exhaust gas from the fuel cell and a gas delivery device arranged downstream of the water separator, in particular adjacent thereto. The water separator has a suction connection for feeding the exhaust gas into the water separator and also a water outlet for removing water separated from the moist exhaust gas. In addition, the water separator has a droplet-free gas connection for droplet-free gas, a moist gas without water droplets, which flows into the gas delivery device.

The purpose is accomplished by the ejector jet pump according to claim 1 in that the water separator between the suction connection and the gas delivery device is tubular in shape and has a bend of at least 60° and at most 160°, in particular 120°. Narrower limits for the angle α can also be selected, whereby the selection must not be arbitrary, rather flow must still be reasonable, i.e., without significant losses. Accordingly, reasonable lower limits for angle α could be 65°, 70°, 75°, 80°, or 85°. Reasonable upper limits for angle α can therefore be 155°, 150°, 145°, 140°, 135°, 130°, 125°, 120°, 115°, 110°, 105°, 100°, or 95°. A right-angled or approximately right-angled bend is particularly preferred.

The water separator may comprise a first pipe section adjacent to the suction connection with a first main axis and a second pipe section adjacent to the gas delivery device with a second main axis, wherein the bend may be arranged between the first pipe section and the second pipe section, and wherein the angle α may be formed between the two main axes. The exhaust gas from an anode of the fuel cell in particular is usually present as a moist hydrogen gas with a liquid component. The droplet-free gas is then a gas, in particular a hydrogen-nitrogen-water vapor mixture, without liquid water droplets. The pipe shape may preferably be circular. However, it is also possible for the pipe to have other shapes, such as an elliptical, polygonal, or square shape, with the corresponding corners rounded. The fuel cell referred to herein may represent a fuel cell stack consisting of a plurality of fuel cells.

The incoming moist exhaust gas with a liquid component is diverted in the ejector jet pump in the water separator, directing the exhaust gas onto a wall of the water separator. The water droplets present in the moist exhaust gas adhere to the walls exposed to the flow, and the gas flow, which is now partially dehumidified, can be conveyed further with minimal friction loss. This is particularly advantageous for an ejector jet pump connected to a liquid hydrogen tank under low pressure to provide a propellant, as there are only very low pressure losses in the water separator and thus in the proposed ejector jet pump according to the invention.

Further advantages and features are apparent from the following description of some preferred embodiments and the dependent claims.

In an advantageous embodiment of the invention, the ejector jet pump is further developed in that the water separator has a water collection ring at its end facing the gas delivery device, from which the water outlet opens. This means that the flow direction within the water separator is the same for both the gas and liquid phases of the moist exhaust gas or its liquid and gaseous components, so that pressure losses can be reduced even further, at least compared to a cyclone. The water collection ring is preferably designed as a collection basin in which the movement of the separated water is directed from the main flow direction to the water outlet. In cross-section, the water collection ring may have a pocket shape.

In another advantageous embodiment of the ejector jet pump, the water collection ring is arranged concentrically with the droplet-free gas outlet. This allows for an overlap of the water collection ring and the droplet-free gas outlet to be achieved. This is a particularly compact and space-saving arrangement of the two components.

In a preferred embodiment of the ejector jet pump, the water collection ring is arranged at a distance from the droplet-free gas connection. This allows easy separation of the separated water from the exhaust gas and the dehumidified droplet-free gas formed from the exhaust gas. Furthermore, the distance between the water collection ring and the droplet-free gas connection, defined in a cross-section of the water collection ring and radially to at least one of the center axis of the water collection ring or the droplet-free gas connection along a radial, may be at least 10% of the cross-section of the water collection ring. The inner wall diameter of the water collection ring is at least one and a half times, in particular at least twice, as large as the inner wall diameter of the droplet-free gas connection.

In a particularly preferred embodiment, the water collection ring is arranged separately from the droplet-free gas connection. This can be achieved, for example, by means of a common partition wall, which can in particular constitute the distance between the water collection ring and the droplet-free gas connection. The separation allows the separated water and the droplet-free gas to be discharged separately in a particularly efficient manner.

In an advantageous further development of the ejector jet pump, the droplet-free gas connection tapers in the direction of flow. This reduces the overall cross-section and allows the gas to be advantageously accelerated in the direction of the gas delivery device. It may also be provided that the outer and the inner wall diameter taper uniformly so that the distance between the outer and inner walls does not decrease.

A particularly preferred design of the ejector jet pump provides that the gas delivery device has a propellant connection for supplying propellant to a delivery chamber of the gas delivery device, and wherein the droplet-free gas and the propellant flow together in the delivery chamber of the gas delivery device. This creates a particularly efficient delivery pump that works well even at low propellant delivery pressures, which is particularly advantageous for aviation applications. The propellant, particularly in an aviation application, is liquid hydrogen in a propellant tank, which is expanded at least in the delivery chamber or already upstream in a supply line and assumes a gaseous form. The propellant is fed into the delivery chamber at high speed, at approximately Mach speed or even supersonic speed, where it draws in the droplet-free gas entering preferably laterally to its flow path, thus creating a pumping or suction effect in the water separator.

The water separator may comprise a first pipe section and a second pipe section, between which a bend may be located. The propellant connection may comprise a third pipe section for feeding the propellant into the delivery chamber, wherein the third pipe section may run in the area of the bend from outside the water separator into the latter, in particular through the pipe wall of the water separator, and may run inside the second pipe section, in particular substantially concentrically with the latter. Substantially concentric can mean that the center of the third pipe section is offset from the center of the second pipe section by no more than 50%, preferably 40%, more preferably 30%, and in particular 20%, of a maximum cross-section dimension of the second pipe section at the relevant point. An ejector jet pump of this type, composed of pipe sections, allows for a particularly simple and lightweight design, which is especially advantageous for aviation applications.

The pipes or the first, second, and third pipe sections may be made of sheet metal or comprise sheet metal pipe walls.

The design of the ejector jet pump may be further improved in particular by connecting the propellant connection to a propellant nozzle that opens into the delivery chamber of the gas delivery device. This results in an even higher propellant velocity upon entering the delivery chamber, so that the suction effect on the water separator is advantageously higher.

It is particularly preferred that the droplet-free gas connection of the water separator is arranged around the propellant connection. This is a particularly compact design, which also has the advantage of introducing less friction into the flow and thus reducing cross-flow.

It may also be advantageous to provide that the propellant connection runs at least in sections through the water separator. Although this creates a slight obstruction in the water separator, the propellant can flow into the delivery chamber without any problems, which is advantageous.

Furthermore, in another preferred embodiment of the ejector jet pump, the droplet-free gas connection and the propellant connection may be arranged concentrically with respect to one another. This has the advantage of achieving both uniform suction at the droplet-free gas connection and uniform mixing in the gas delivery device.

Furthermore, in another embodiment of the ejector jet pump, the gas delivery device may be provided with a diffuser downstream of the droplet-free gas connection. A diffuser slows down the outflowing gas, allowing the ejector jet pump to be integrated into a recirculation system with minimal loss.

### BRIEF DESCRIPTION OF THE DRAWING

The invention will be explained in more detail with reference to the following drawings, based on a number of preferred embodiments of the invention.

FIG. 1 shows a schematic representation of a recirculation system with an embodiment of a jet ejector pump according to the invention

FIG. 2 shows the embodiment of the jet ejector pump according to the invention in a perspective view from the outside

FIG. 3 shows a sectional view of the embodiment of the jet ejector pump according to the invention shown in FIG. 2

### DETAILED DESCRIPTION

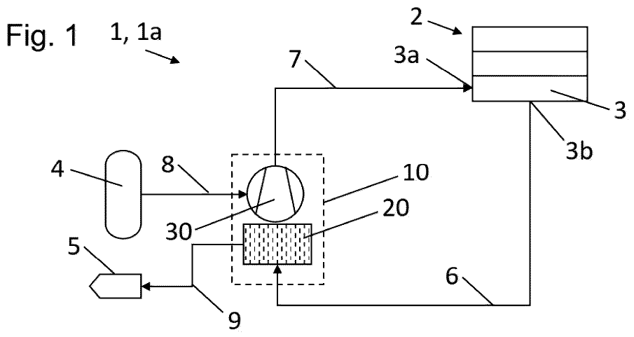

FIG. 1 shows a schematic representation of an example of a recirculation system 1 of a fuel cell drive 1a.

The recirculation system 1 features an ejector jet pump 10 according to an embodiment of the invention. In the present embodiment, the ejector jet pump 10 consists of a water separator 20 and a gas delivery device 30. The recirculation system 1 further comprises at least one fuel cell 2 from a fuel cell stack with at least one anode 3, wherein an anode inlet connection 3a and an anode outlet connection 3b are provided on at least one anode 3. A first recirculation line 6 leads from the anode outlet connection 3b to the water separator 20 of the ejector jet pump 10, and a second recirculation line 7 leads from the gas delivery device 30 of the ejector jet pump 10 to the anode inlet connection 3a.

Furthermore, at least one propellant tank 4 supplies the ejector jet pump 10 with a propellant, in the present embodiment with liquid hydrogen, via a supply line 8. The supply line 8 is connected to the gas delivery device 30.

Finally, a discharge line 9 leads from the water separator 20 to a water system 5 of the fuel cell system.

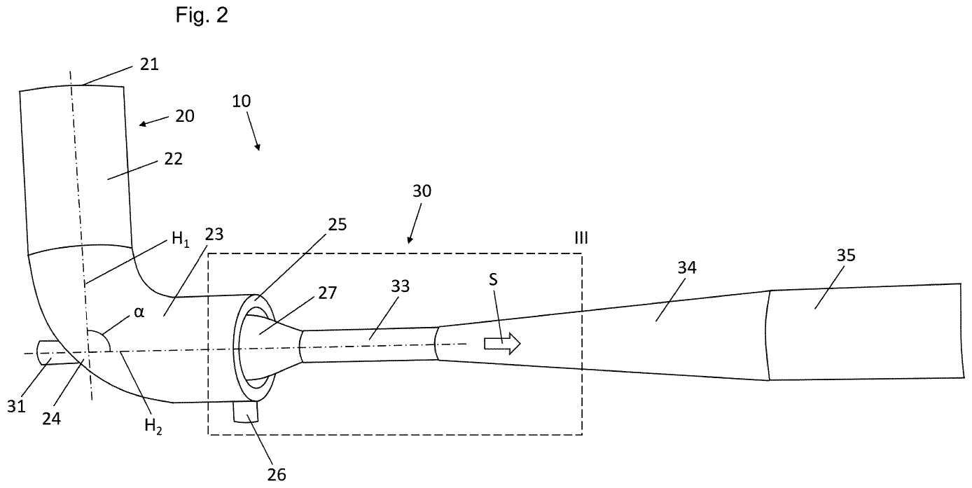

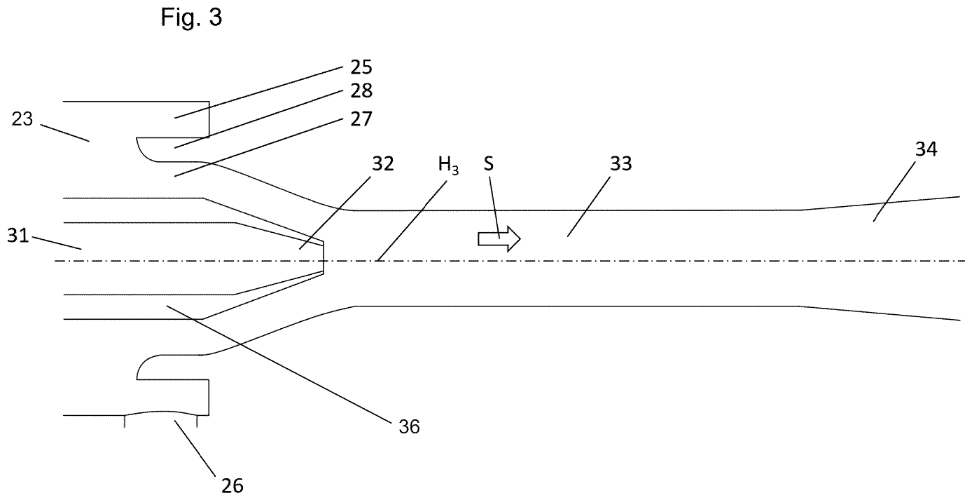

FIG. 2 shows a perspective view of the embodiment of the ejector jet pump 10 according to the invention shown in FIG. 1. The ejector jet pump 10 consists of a water separator 20 and a gas delivery device 30. A sectional view of a portion of the ejector jet pump 10 is marked by a rectangle drawn with dashed lines and labeled III, and is shown in FIG. 3.

The water separator 20 has a suction connection 21 for connection to the first recirculation line 6 and also comprises a first pipe section 22 and a second pipe section 23, between which a bend 24 is arranged, or which merge into each other with the bend 24, and a concentrically arranged water collection ring 25 with a water outlet 26 downstream of the second pipe section 23, as well as a droplet-free gas connection 27 arranged concentrically to the water collection ring 25. The water outlet 26 is arranged in and on a wall of the water collection ring 25 opposite the suction connection 21 and directs the falling water from there via the discharge line 9 to the water system 5 of the fuel cell system for further use. The opposite arrangement of the water outlet 26 is advantageous due to its proximity to the wall of the water separator 20 against which the flow occurs, because the majority of the falling water will form on the wall that is exposed to the flow.

The two pipe sections 22, 23 are cylindrical in this embodiment, but may also have other shapes as indicated in the introductory description. The first pipe section 22 has a first main axis H₁ and the second pipe section 23 has a second main axis H₂. The main axes H₁ and H₂ intersect and form an angle α, which, according to the invention, can have a value between 60° and 120° and, in the present embodiment, is 90°. Accordingly, the water separator 20 has a 90° bend 24.

This bend directs the moist exhaust gas flowing in from the suction connection 21 toward the inner wall of the water separator 20 and can release water there, resulting in dewatered, droplet-free gas that can flow along the direction of flow S through the droplet-free gas connection 27, which is located further inside relative to the water collection ring 25, with as little loss as possible.

The gas delivery device 30 is connected to the droplet-free gas connection 27. The gas delivery device 30 comprises a propellant connection 31 with a propellant nozzle 32 shown in FIG. 3 which opens into the delivery chamber 33 of the gas delivery device 30, a diffuser 34 arranged downstream of the delivery chamber 33, and a downstream gas outlet connection 35 for connecting the ejector jet pump 10 to the second recirculation line 7.

FIG. 3 shows a section of the ejector jet pump 10 shown in FIG. 2 in a sectional view, in particular the connection between the water separator 20 and the gas delivery device 30. In the present embodiment, the gas delivery device 30 has a third main axis H₃ which runs identically to the second main axis H₂.

The water collection ring 25, an inlet of the droplet-free gas connection 27, and a section of the propellant connection 31 positioned immediately upstream of the propellant nozzle 32 in the direction of flow S are arranged concentrically and adjacent to each other around the third main axis H₃ of the gas delivery device 30.

A partition wall 28 is arranged between the water collection ring 25 and the inlet of the droplet-free gas connection 27, which separates the water collection ring 25 from the droplet-free gas connection and gives the water collection ring 25 a container-like ring shape in which water can collect. The water can then be drained through the water outlet 26 in the water collection ring 25. The partition wall 28 is rounded on the side facing the droplet-free gas connection 27 in order to reduce flow resistance in the droplet-free gas connection 27, while the partition wall 28 is fully formed on the side facing the water collection ring 25, thus providing the largest possible inner surface area for the water collection ring 25. This advantageously enlarges the interior space of the water collection ring 25, which serves as a water collection container.

It can also be seen that the droplet-free gas connection 27 is arranged around the propellant nozzle 32 and has a height that is constant in the radial direction around the third main axis Hs along the direction of flow, but tapers in the direction of flow S, which corresponds to that of the propellant nozzle 32. This reduces the cross-section of the droplet-free gas connection 27, so that the dehumidified droplet-free gas is accelerated. Since the propellant emerging from the propellant nozzle 32 also has a high flow velocity, this can advantageously reduce turbulence, i.e., the proportion of cross-flows. It is understood that the height of the droplet-free gas connection 27 may also taper in the direction of flow in other embodiments, for example to further increase the acceleration of the flow.

The propellant exiting from the propellant nozzle 32 sucks in the droplet-free gas due to the high flow velocity and transports it through the delivery chamber 33. When flowing through the delivery chamber 33, which is essentially cylindrical in shape, the droplet-free gas and propellant are mixed, which further reduces the moisture content of the exiting gas mixture due to the completely dry, i.e., water-free state of the propellant. The gas mixture at the end of the delivery chamber 33 finally reaches the diffuser 34, whose cross-section widens, slowing the flow to a speed that can be used in the recirculation line 6 connected to the gas outlet connection 35.

The combination of water separator 20 and gas delivery device 30 with a propellant connection 31 thus advantageously forms an efficient ejector jet pump with an embedded water separator.

### REFERENCE LIST

1 Recirculation system
1a Fuel cell drive
2 Fuel cell
3 Anode
3a Anode inlet connection
3b Anode outlet connection
4 Propellant tank
5 Water system
6 first recirculation line
7 second recirculation line
8 Supply line
9 Discharge line
10 Ejector jet pump
20 Water separation chamber
21 Suction connection
22 first pipe section
23 second pipe section
36 third pipe section
24 Bend
25 Water collection ring
26 Water outlet
27 Droplet-free gas connection
28 Partition wall
30 Gas delivery device
31 Propellant connection
32 Propellant nozzle
33 delivery chamber
34 Diffuser
35 Gas outlet connection
α Angle between the first and second principal axes
H₁ first main axis
H₂ second main axis
H₃ third main axis

What is claimed is:

1-13. (canceled)

14. An ejector jet pump for a recirculation system of a fuel cell system in a fuel cell drive for humidifying and recirculating hydrogen in the fuel cell system, with at least one fuel cell, the ejector jet pump comprising:
a water separator for separating liquid water and forming droplet-free gas from a moist exhaust gas from the fuel cell; and
a gas delivery device arranged downstream of the water separator,
the water separator having a suction connection for feeding the exhaust gas into the water separator,
wherein the water separator has a water outlet for discharging water separated from the moist exhaust gas,
wherein the water separator has a droplet-free gas connection opening into the gas delivery device,
the water separator between the suction connection and the gas delivery device being tubular in shape and having a bend at an angle α of at least 60° and at most 160°.

15. The ejector jet pump as recited in claim 14 wherein the water separator has a water collection ring at an end facing the gas delivery device, from which the water outlet opens.

16. The ejector jet pump as recited in claim 15 wherein the water collection ring is arranged concentrically with the droplet-free gas outlet.

17. The ejector jet pump as recited in claim 15 wherein the water collection ring is arranged at a distance from the droplet-free gas connection.

18. The ejector jet pump as recited in claim 15 wherein the water collection ring is arranged separately from the droplet-free gas connection.

19. The ejector jet pump as recited in claim 14 wherein the droplet-free gas connection tapers in the direction of flow.

20. The ejector jet pump as recited in claim 14 wherein the gas delivery device has a propellant connection for supplying a propellant to a delivery chamber of the gas delivery device, and wherein the droplet-free gas and the propellant flow together in the delivery chamber of the gas delivery device.

21. The ejector jet pump as recited in claim 20 wherein the water separator includes a first pipe section and a second pipe section between which the bend is located, wherein the propellant connection includes a third pipe section for supplying the propellant to the delivery chamber, wherein the third pipe section extends into the water separator from outside the water separator in the region of the bend and runs inside the second pipe section.

22. The ejector jet pump as recited in claim 20 wherein the propellant connection opens into the delivery chamber of the gas delivery device with a propellant nozzle.

23. The ejector jet pump as recited in claim 20 wherein the droplet-free gas connection of the water separator is arranged around the propellant connection.

24. The ejector jet pump as recited in claim 20 wherein the propellant connection extends at least partially through the water separator.

25. The ejector jet pump as recited in claim 20 wherein the droplet-free gas connection and the propellant connection are arranged concentrically to each other.

26. The ejector jet pump as recited in claim 14 wherein the gas delivery device has a diffuser downstream of the droplet-free gas connection.

27. The ejector jet pump as recited in claim 14 wherein a fuel cell drive designed as an aircraft engine.

28. The ejector jet pump as recited in claim 14 wherein the gas delivery device arranged downstream of the water separator is adjacent thereto.

29. The ejector jet pump as recited in claim 21 wherein the third pipe section extends into the water separator through the pipe wall of the water separator, and runs inside the second pipe section concentrically with it.
